(19) United States
(12) Patent Application Publication
(10) Pub. No.: US 2012/0296855 A1
(43) Pub. Date: Nov. 22, 2012

(54) QUANTIFYING, ANALYSING, MONITORING AND IMPROVING HAPPINESS

(76) Inventors: Eynat MATZNER, Adi (IL); Yoni RAVEH, Alon (IL)

(21) Appl. No.: 13/441,881

(22) Filed: Apr. 8, 2012

Related U.S. Application Data
(60) Provisional application No. 61/457,690, filed on May 16, 2011.

(51) Int. Cl. G06F 17/20

(52) U.S. Cl. 706/11

(57) ABSTRACT

A method based on the economical concept of NPV for to analyze the emotion of happiness in people by collecting data on emotions regarding an event or action, from a perspective of at least two time periods, and calculating the person's happiness level.

### CROSS-REFERENCE TO RELATED APPLICATIONS

This patent application claims priority from and is related to U.S. Provisional Patent Application Ser. No. 61/957,690, filed 16 May 2011, this U.S. Provisional patent application incorporated by reference in its entirety herein.

### TECHNICAL FIELD

The present invention relates to a method of monitoring, quantifying and improving people's happiness, based on analyzing the NPV model of the happiness as proposed in the invention.

### BACKGROUND ART

Happiness study and the pursuit of well being are central to many human activities:
Academic disciplines such as psychology, medicine, philosophy and sociology.
Establishments such as families, states and economic organizations.

Positive psychology was established in the second half of the 20^{th} century to understand the origin of well being and to find ways to make people happier. There is a very large body of academic work and popular books describing the understanding and offering recipes to increase happiness.

Two of the many findings described in the literature are that Happiness lies at the intersection between pleasure and meaning, and that happiness feeling takes into account short term and long term parameters.
1. Happiness lies at the intersection between pleasure and meaning. This means that happiness feeling takes into account short term and long term parameters.
2. Each person has a basic level of happiness that is a result of his genetics and upbringing (Happiness set point). A person's happiness fluctuates around the basic level, according to events.

In other words, happiness is the combination of short term feelings such as good feeling and enjoyment and serving of a meaningful purpose or important values. If the combination of short term feeling and the long term values that are served is all together positive—happiness will be experienced.

For example:
A fat person may enjoy eating a big meal, but the knowledge that this will make him fatter actually makes him unhappy about the entire event of the meal.
A person may be training for a marathon, be tired, feel physical pain, wake up early to run in harsh conditions and generally “not enjoy” the short term, but the knowledge that he is serving a longer term positive purpose will make him happy despite the hardship.
A University student has to study many hours a day, work during the night to make a living, prepare for difficult exams, but can still feel happy as he is serving the value of education and is expecting to improve his economic and social confidence in the future with the degree that will be achieved.

### SUMMARY

According to a first aspect of the present invention there is provided a computerized method of monitoring and quantifying a person's level of happiness following an event or action, comprising: a. receiving from the user a definition of an event or action via an electronic communication device; b. receiving from the user at least one short-term and one long-term periods related to said event via said electronic communication device; c. receiving from the user a definition of happiness contributors for each said defined periods via said electronic communication device; d. associating grades to each of said contributors; e. computing at the server a happiness level based on said defined happiness contributors' grades; f. computing at the server a happiness rate of said user based on the computed happiness level and the number of periods, using the Net Present Value (NPV) formula, wherein the net present value is represented by said computed user's happiness level; g. storing at the server said received and computed happiness parameters; h. reporting said computed happiness parameters to the user; i. repeating steps (a) through (h), wherein said previously stored happiness parameters are used to detect patterns in the user's happiness level; and (i) using said detected patterns to refine the NPV formula for the user.

The associating grades may comprise recording said user's voice via said electronic communication device and performing a computerized analysis thereof at the server. The associating grades may comprise capturing said user's expressions via said electronic communication device or voice and performing a computerized analysis thereof at the server.

The electronic communication device may be selected from the group consists of: a Smartphone, a personal computer, a tablet PC and a PDA.

The method may further comprise using the NPV formula to help in the user's decisions based on achieving the highest happiness level as represented by the NPV.

The method may further comprise retrieving additional data related to said defined event or action from personal electronic sources.

The additional data may comprise at least one of time and location of the event or action,

The personal electronic sources comprise at least one of a Smartphone and a personal computer.

The method may further comprise correlating said additional data with said user's happiness level.

The method may further comprise retrieving additional data related to said defined event or action from public electronic sources.

The additional data may comprise at least one of weather, political events, social events and astrological events, correlated with the event or action.

The public electronic sources may comprise the Internet.

The method may further comprise correlating said additional data with said user's happiness level.

The method may further comprise reporting said computed happiness parameters.

The method may further comprise providing means for sharing the computed happiness level with a selected list of online social networks.

The method may further comprise storing the computed happiness level of a plurality of users at the server and performing correlations and pattern finding in said stored data. According to a second aspect of the present invention there is provided a system for monitoring and quantifying a user's level of happiness following an event or action, comprising: a server connected to a network, said server comprising a processor and configured to execute programmable commands of a server application; at least one electronic communication device communicating with said server over a network, said electronic communication device comprising a processor and configured to execute programmable commands of a client application; said electronic communication device additionally comprising a display configured to provide a GUI (Graphical User Interface) means for receiving user input and providing output to the user; wherein said user GUI input means comprise: means for defining an event or action; means for defining at least one short-term and one long-term periods related to said event or action; means for defining happiness contributors for each said defined periods; and means for associating grades to each of said contributors; said server processor further configured to: compute a happiness level based on said defined grades; compute a happiness rate of said user based on the computed happiness level and the number of periods, using the Net Present value (NPV) formula, wherein the net present value is represented by said user's happiness level; and wherein said GUI means further comprise means for reporting said computed happiness parameters to said user.

The electronic communication device may further comprise recording means for recording said user's voice and transmit said recording to the server, said server processor further configured to analyze said recorded voice and refine said associated grades accordingly.

The electronic communication device may further comprise capturing means for capturing said user's expressions or voice and transmit said captured expressions or voice to the server, said server processor further configured to analyze said captured expressions and refine said associated grades accordingly.

The GUI may comprise means for sharing the computed happiness level with a selected list of online social networks.

The electronic communication device may be selected from the group consisting of Smartphone, personal computer, tablet PC and PDA.

According to a third aspect of the present invention there is provided a system for monitoring and quantifying a population's level of happiness following an event or action, comprising: a server connected to a network, said server comprising a processor and configured to execute programmable commands of a server application; multiple electronic communication devices communicating with said server over a network, each one of said plurality of electronic communication devices comprising a processor and configured to execute programmable commands of a client application; each one of said plurality of electronic communication devices additionally comprising a display configured to provide GUI (Graphical User Interface) means for receiving users input and providing output to the users; wherein said user GUI input means comprise: means for defining an event or action; and means for defining a happiness level of a user said server processor further configured to: compute statistics of happiness level of populations comprising multiple users and reporting said computed happiness level and statistics of said populations to other parties.

The means for defining a happiness level of a user may comprise means for capturing said user's expression or voice.

The computed statistics of happiness level of said population may be presented by means of graphical and numerical data.

The other parties may comprise stake holders selected from the group consisting of: municipalities, government institutes and educational institutes.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 depicts a pictorial representation of a distributed data processing system in which the present invention may be implemented;

FIG. 2 is a table demonstrating and exemplary happiness contributors calculation;

FIG. 3 is a flowchart showing the various steps taken by the application according to a first embodiment;

FIG. 4 is a flowchart showing the various steps taken by the application according to a second embodiment;

FIGS. 5 through 9 are exemplary implementations of a user interface for implementing the present invention; and

FIG. 10 shows an exemplary report of a statistical happiness analysis over a population.

### DETAILED DESCRIPTION OF PREFERRED EMBODIMENTS

The present invention provides a method of monitoring a person's view of at least two time frames with regards to the emotions the person experiences. The NPV (Net Present Value) model for happiness aims to quantify these observations. The model borrows the concept of NPV from economics, and calculates the “net present value” of happiness based on the details of an event or action a person was involved in.

In economics, the NPV is calculated using the following formula:

NPV=CF₀+CF₁/(1+r)+CF₂/(1+r)²+CF₃/(1+r)³ . . .

where CF₀ is the investment cash flow, CF₁ is the cash flow the investor receives in the first year, CF₂ is the cash flow the investor receives in the second year etc. and r is the interest rate.

The same formula is used by the present invention to calculate Happiness NPV, where:

The interest rate (r) represents the “basic attitude” of the person or his basic ability to be happy, that determines the basic level of happiness. The “Happiness rate”, is expected to be characteristic of a person, although a person may have somewhat different rates for different type of events.

The “cash flows” (CFᵢ) are the net summary of the person's emotion at each calculated time. In the short term it is the enjoyment and good feelings arising from events or actions (bad feelings will be considered as negative) and in the long term the “cash flows” represent the values and confidence served by an activity or spent on an activity. If the activity is believed not to serve a person's values the long term CF will be negative as well.

“Happiness contributors” are the feelings contributing to the total happiness of the person, these can be short term enjoyment and long term satisfaction or confidence due to serving values that are important for the person. Happiness contributors may be negative when an action causes bad feeling or the person believes it is harmful to important values.

The model takes a number of time periods, estimates the amount of happiness (summary of the happiness contributors) that is expected (or is already felt) and the “Happiness rate” of the person.

The concept behind it is that a person will be happy in the present if the total sum of the happiness “cash flows” in the present and future, taking into account the person's attitude and ability for happiness, is positive.

The model uses at least two periods: Short term for feelings and long term for values.

Preferably the system will monitor four periods relevant to the NPV:

Period 1—during the activity
Period 2—short term—right after the event
Period 3—mid-term—values served
Period 4—long term—confidence.

The model uses four major happiness contributors:
1. Sensation during activity (SDA)
2. Feelings after completion (FAC)
3. Mid-term values served (VS)
4. Long term confidence (LTC)

As the NPV is used in economics, if the NPV of happiness is positive, the person feels happy in the present.

Basically a person uses the model during periods 1 and 2 which represent the present, when the action or event actually takes place, but he always needs to look forward to the future represented by periods 3 and 4 in order to quantify the happiness felt in the present.

The calculation will be:

Happiness=feeling During action+feeling short term(right after)/(1+r)+mid-term(values served)/(1+r)̂2+long term(confidence)/(1+r)̂3

Or

Happiness=SDA+FAC/(1+r)+VS/(1+r)̂2+LTC/(1+r)̂3

In the economic model of NPV, (1+r)̂3 means 3 years after the original investment.

In the case of happiness, the long term confidence may actually span over a longer term than just 3 years, and the values served may be important for more than 2 years.

So within the model there is an option to optimize the times, in order to achieve a stable r value (happiness attitude) for a person, as will be shown with reference to Example 1.

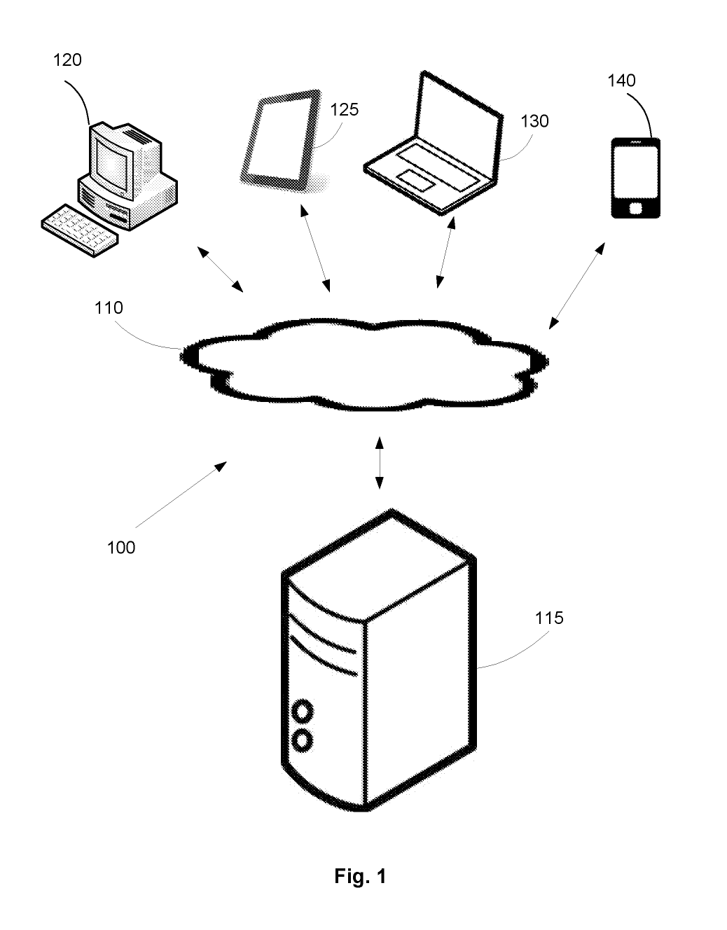

In general, embodiments of the invention can be implemented in any of a variety of hardware/software configurations. A particular embodiment includes at least one client computer and at least one server computer. The client(s) and server(s) may be executing on a common machine or may be deployed in distributed environment in which the client(s) and server(s) communicate via a network (such as will be described below with respect to FIG. 1). However, the client-server model is merely one model in which the present invention may be implemented, and persons skilled in the art will recognize other possibilities. Furthermore, embodiments of the present invention can apply to any appropriate hardware configuration, regardless of whether the computer systems are complicated, multi-user computing apparatus, single-user workstations, network appliances that do not have non-volatile storage of their own or handheld devices such as personal digital assistants (PDAs), laptops, tablet computers and mobile telephones. Further, it is understood that while reference may be made to particular software products, the invention is not limited to a particular software product, standard or version nor to any particular programming language. Accordingly, persons skilled in the art will recognize that the invention is adaptable to other software products and that the invention is also adaptable to future versions of a particular software product as well as to other suitable software products presently unknown.

With reference now to the figures, FIG. 1 depicts a pictorial representation of a distributed data processing system 100 (also referred herein as a network environment) in which the present invention may be implemented. The distributed data processing system 100 contains a network 110, which is the medium used to provide communications links between various devices and computers connected together within distributed data processing system 100. The network 110 may include permanent connections, such as wire or fiber optic cables, or temporary connections made through telephone connections and may also include wireless connections. Generally, the network 110 may be implemented as a number of different types of networks, such as, for example, an intranet, a local area network (LAN), or a wide area network (WAN). In a particular embodiment, the network 110 is the Internet.

In the depicted example, a plurality of computers is connected to the network 110. The computers include a server computer 115 and exemplary client computers comprising a desktop computer 120, a tablet PC 125, a laptop 130 and a Smartphone 140. It is understood that FIG. 1 is merely illustrative. Thus, the distributed data processing system 100 may include other forms of server systems (not shown), which also provide data to the client computers. For example, one form of a server system may comprise two or more servers that have been logically associated with each other or interconnected as a cluster. The distributed data processing system 100 may include additional servers, clients, and other devices not shown.

The client computers according to the present invention run a client application having a Graphical user Interface (GUI) and communicate over the network with a server application residing on the server computer. The server additionally comprises a database storing registered users' profile information and data related to each user's happiness as collected and calculated by the system, as will be explained in detail below.

The method according to the present invention comprises collecting and monitoring a person's happiness directly through the person's reporting on his state via cellular or internet connected device such as a personal computer, or indirectly through such a device monitoring and analyzing the person's voice when he talks on the cellular device, to detect joy, sadness, or other emotions that are detectable by the voice. Non-limiting examples of voice analyzing are described in U.S. Pat. Nos. 7,165,033, 8,078,470 and 7,451,079, all of which are herein fully incorporated by reference. If the user uses an internet camera, his facial expressions may be detected and analyzed to detect whether he smiles, cries or expresses other detectable emotions and other physical signals that are available and point to a person's emotion, such as body language and movements.

A non-limiting example of expression analyzing is described in U.S. Pat. No. 8,098,273, which is herein fully incorporated by reference.

The method according to the present invention further monitors the events occurring to the person by direct reporting of the person, or in addition or solely using information that is available in the cellular device or the internet connected device, such as the location of the event, the time in which it occurred, the weather information that is available for the time and location, the known political (or other) events known to have happened at the same time.

The inputs from such information sources are then analyzed and correlated with the person's reported happiness level to further understand the causal effects on the person's happiness level. For example, every time it rains he is less happy. So when the system is required to advise and recommend it can take into account the weather. (or time of day or location). For larger population statistics, if the ministry of education finds that every summer holiday the students' level of happiness drops, they may decide to change the way the holidays are planned. Or if the municipality of a city finds that people are happiest in the city's central park, they may invest more there.

The method according to the present invention comprises analyzing the NPV data collected from individuals to understand larger populations' happiness, happiness contributors and attitudes. The invention also allows sharing of the information between users.

When a user first uses the client application, after having been registered, he is prompted to input the following information:
User's basic profile (age, location, profession etc.)
Definition of people he mostly interacts with, e.g. family members, friends, co-workers, etc, the main locations he frequents such as home and work, to allow monitoring of his happiness during interactions with the people and in these places and some information about the person's basic happiness level that can be identified by few questions.

During ongoing usage the system:
Monitors user's happiness during activities and events by sampling him. e.g. through the cellular device or computer.
Monitors user's happiness through the user's own summary and overview of events and activities.
Allows user to specify his happiness contributors in a few levels of detail.
Allows the user to report on himself and summarize his experiences as related to happiness.
Registers the user's location, time of day and year and any other information that is known through the cellular phone or public media when an event or sampling is taking place.
Registers information that is available when location and time are known, such as weather, political events in the proximity, holidays taking place etc.
Allows the user to report on the events and actions he is involved with during the happiness sampling.

### System Outputs:

Level 1: Provides user with reports on his happiness and correlations of his happiness level with other parameters (such as time, place, weather, people he is with etc.).
Level 2: Allows user to share his happiness level with a selected list of social networks.
Level 3: Looks for patterns in user's happiness level with regards to the above parameters and establishes and refines the “Happiness NPV” model based on the established database.
Level 4:
1. Uses the model to build user's profile in terms of his contributors and happiness rate and guides him in choices to increase happiness.
2. Uses user's patterns and profile to help him succeed in activities that are happiness related, such as diet, physical activity, dating.
3. Looks for patterns of happiness and Happiness NPV in larger populations and groups to allow theoretical understanding and improvements.

### Additional Features

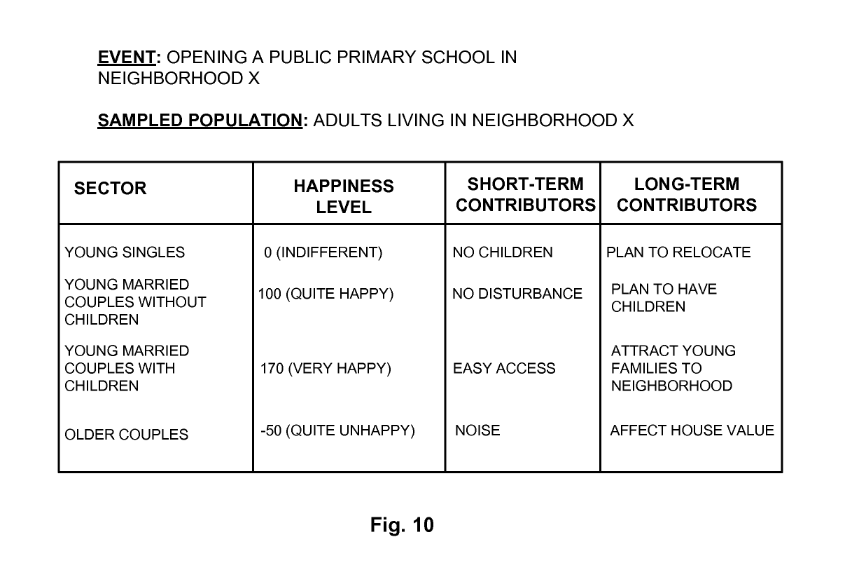

The system and model allow more detailed happiness analysis related to more well defined activities such as: hobbies, sports, family relationships, travel.
The model can follow a person's happiness improvement through changes in his happiness rate.
The parameters checked for understanding contributors may change according to a person, for example: if a person normally feels anger and disappointment when he meets a certain person, the application may ask about these feelings as a first option, to make the sampling easier.
The NPV model can adjust the contributors for such specific activities allowing higher resolution of happiness.
The system can collect the happiness level of multiple users and populations and use this data to produce statistics of larger populations' level of happiness with regards to events and actions occurring to these populations. This data may be shared with stake holders such as municipalities, government, educational institutes etc. to better understand and improve their performance as it relates to the happiness of the population in their care. The statistics relating to the population's happiness may be presented graphically, using 2-dimensional or 3-dimensional graphs, or numerically using tables, as demonstrated, for example in FIG. 10. It may also be represented by a color codes on a map of a certain geographic area.

### Example 1

### Analysis of an Event 1:

Event=argument with the boss

### Grading by the User

A person will be asked to give his total happiness and how it is combined from the four time periods. It may look like this:
a. How happy are you now (−200 to 200)→−40
b. Because?→I had an argument with my boss
c. Give values to the four contributors:
   During the argument: −15
   Immediately after completion: −23
   Values that the argument served: −10
   Long term confidence: −2
      With these 4 values in the NPV equation, the person's happiness rate can be calculated to be 0.28.

Now, when the person describes more events, this happiness rate is challenged. In order to have one happiness rate and one consistent equation for a person, the software can slightly modify the NPV calculation:
Add more “periods” which do not add to the contributors but change the calculation of the happiness rate (to higher powers)
Add a coefficient to the person's estimated contribution of any of the time periods (such as multiplying the SDA by 1.5)
Add a certain constant value to the total happiness the person reports
Other mathematical ways that may be suitable.

For example, the same person may now report another event: going out for dancing with his wife.
a. How happy are you now (−200 to 200)→94
b. Because?→I had an evening out dancing with my wife
c. Give values to the four contributors:
   During the evening: 36
   Immediately after completion: 33
   Values that the outing served: 27
   Long term confidence: 20

With these 4 values in the NPV equation, the person's happiness rate can be calculated to be 0.195.

This means that the model is not yet stable, as the same person has two very different r values. In order to make the model suitable for both cases the calculation is optimized:

Happiness=SDA+FAC/(1+r)+0.5VS/(1+r)̂2+LTC/(1+r)̂3+0.5VS/(1+r)̂4+LTC/(1+r)̂5

With this new refined model, the person's r is 0.235 for both events, and we understand that the values and confidence are important in the longer term for this person, and that confidence is more critical for him than values.

How does a person quantify each contributor?

The application provides a list of parameters (the parameters themselves may be adjusted to a person as will be described below) for each contributor and each parameter is graded from 1-10 for SDA and FAC, and from −10-+10 for VS and LTC.

For example:

| | Periods and happiness contribution | | | |
|---|---|---|---|---|
| | SDA | | | |
| | Sensation | FAC | | LTC |
| | during | Feeling after | VS | Long term |
| | action | completion | Values served | confidence |
| Posi- | Exciting, | Strength, | Justice, | Economic |
| tive | pleasure, | freedom, | self | Moral |
| | tasty, funny, | accomplishment, | improvement, | Social |
| | interesting, | success, | contribution to | Physical |
| | beautiful, | acceptance, | other people | Intellec- |
| | fun, | love, | improvement of | tual |
| | relaxing | understanding | the world | |
| Nega- | Boring, | Weakness, | religious rules. | |
| tive | painful, | humiliation, | Get closer to | |
| | scary, | failure, | fulfill self | |
| | insulting, | loneliness, | aspirations | |
| | difficult, | rejection, | | |
| | disgusting, | uncertainty | | |
| | stressing | | | |

Happiness=SDA+FAC/(1+r)+VS/(1+r)̂2+LTC/(1+r)̂3

A collection of events should all give the same r value.

Refining the model, by addition of periods or constants can be done to achieve consistency, as shown above.

Going back to the exemplary argument with the boss:
a. How happy are you now (−200 to 200)→−40
b. Because?→I had an argument with my boss
c. Give values to the 4 contributors:
   During the argument: −15
   Immediately after completion: −23
   Values that the argument served: −10
   Long term confidence: −2

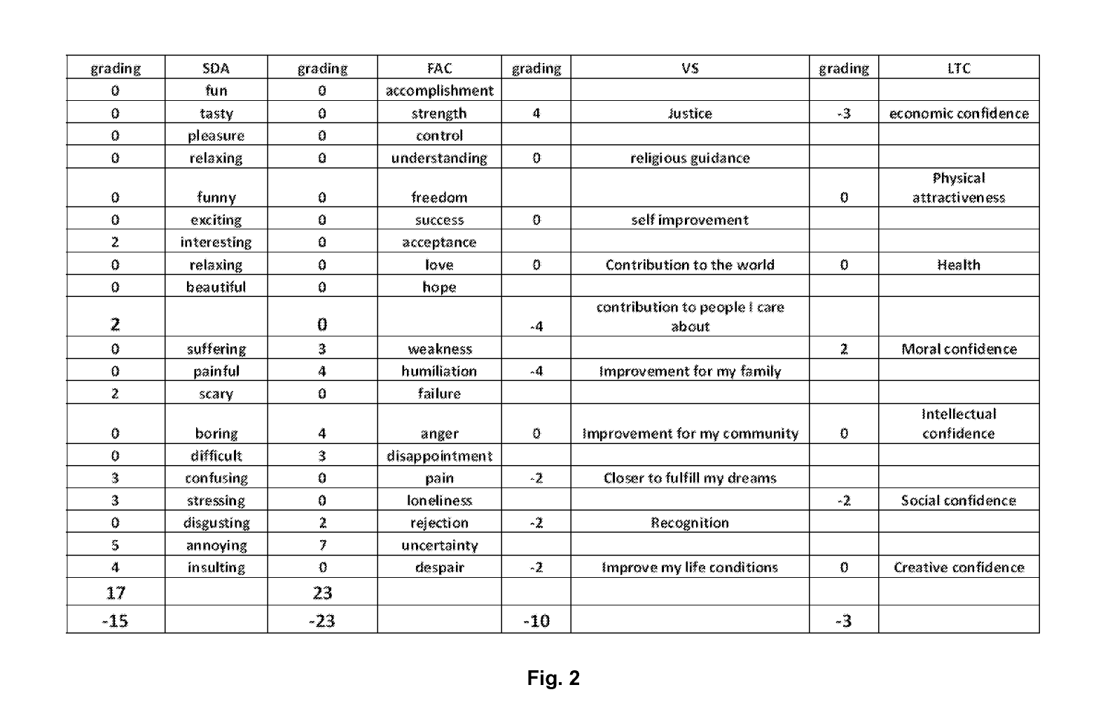

FIG. 2 demonstrates how the contributors were calculated. The actual details, for example: the number and type of feelings, the grading scale (1-10) etc. may be selected in the future according to the needs.

Total happiness reported: −40 (NPV)

−40=−15+−23/(1+r)+−10/(1+r)²+−3/(1+r)³

Calculated “happiness rate”: r=28%

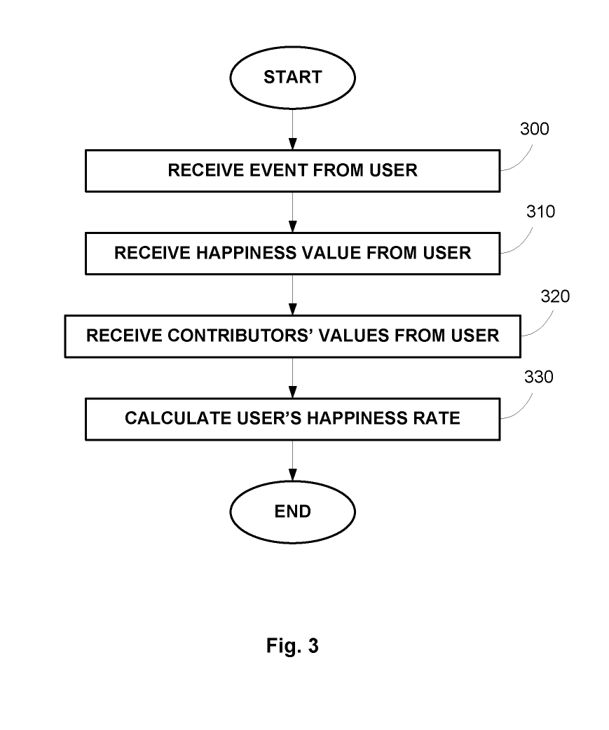

FIG. 3 is a flowchart showing the various steps taken by the application in reference to the example above (Event 1). In step 300 the system receives the event (e.g. “Argument with the boss” from the user. In step 310 the system receives the user's currently perceived happiness level (e.g. 40). In step 320 the system receives values for contributors to the user's happiness pertaining to different periods and in step 330 the system calculates the user's happiness rate using the NPV formula.

Although we assume a constant r for a person, we actually expect that a person who is developing awareness and works on the happiness issue may change his r slightly over time.

Also it may be assumed that a trauma will make a change in r, and that aging will change the r gradually.

It may be the case that a person will have a few typical r values according to the type of event or activities. For example, events that involve the well being of his children may have a typical r, and events that involve the work relationship a different r.

These r values can be learned by collecting enough information about the person's happiness levels.

### Example 2

### Analysis of an Event 2:

The happiness data of the person is collected partially indirectly.

Event: A weekly telephone call with the person's mother.
The data on: date of the call, time, the person on the phone are gathered from the cellular system.
Happiness: monitored by the person's voice using a voice analyzing software: −20

The person reports on two time periods regarding the weekly call:
During the call he was sad due to his mother's health issues: −60
He believes the call is serving an important value of respecting ones parents: +50

Using the equation:

Happiness=SDA+FAC/(1+r)+VS/(1+r)̂2+LTC/(1+r)̂3

−20=−60+0+50/(1+r)̂2

r=0.17

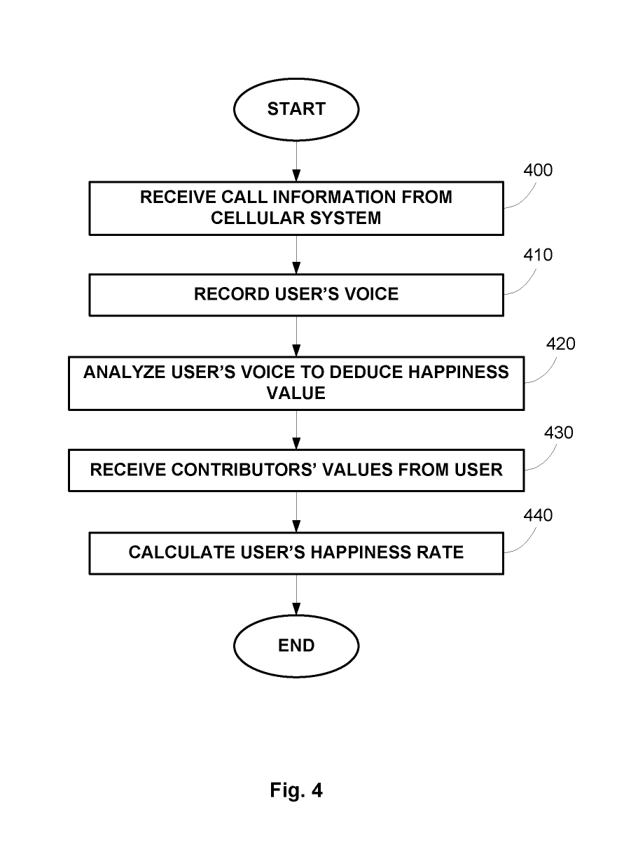

FIG. 4 is a flowchart showing the various steps taken by the application in reference to the example above (Event 2). In step 400 the system receives a call information from the cellular system (e.g. called number or person). In step 410 the system records the user's voice during the conversation. In step 420 the system analyzes the recorded voice to deduce a happiness level. In step 430 the system receives happiness contributors' values pertaining to different periods from the user and in step 440 the system calculates the user's happiness rate using the NPV formula.

The system can issue a report to the person saying that every week, when he is calling his mother he shows negative happiness.

By asking summarizing questions, the model may estimate the persons' main values and the importance of contributors. This may be integrated into the model and help in finding the person's NPV equation.

Happiness contributors may be estimated by such summarizing questions according to the following parameters:
Physical: health, beauty, sport, sexual attraction, food.
Economic: money making, spending, losing, investments.
Social: family, community, relationship.
Moral: religion, charity, social justice, political opinions, personal integrity
Intellectual/creative: art: music, cinema, graphic arts, literature. Science. Education. Intellectual games.

The NPV model of a person can guide the person in decisions:

User will get general guidance
Where to put more efforts in order to improve happiness
What to avoid to reduce suffering

As the database grows, the system can further guide the user in his decision making:
Should I go back to school?
Should I get married?
Should I look for a new job?
Should I go biking on this rainy day?
Should I meet my mother in law today?
Should I discuss the future vacation with my spouse?

What are the chances that any of these will make me happy?

The NPV of happiness allows:
Understanding the reason for the level of happiness in different situations.
Understanding the differences between individuals
Analysis of choices based on happiness when multiple options are available.

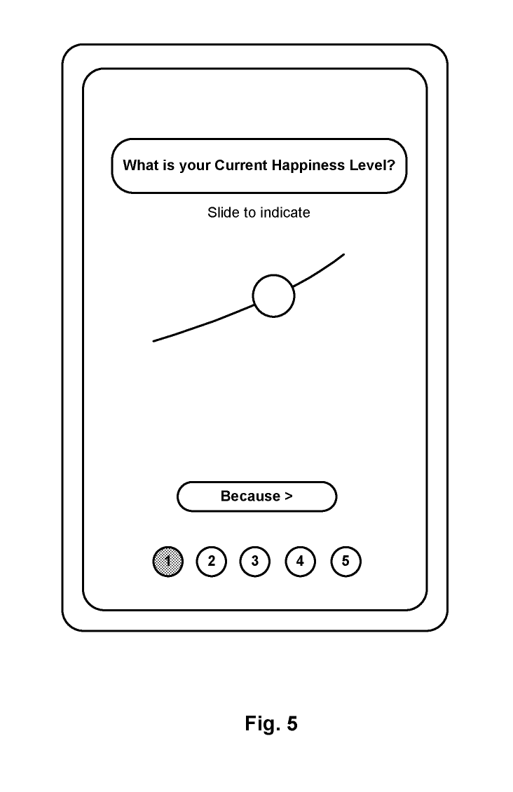

FIGS. 5 through 9 present exemplary GUI screens displayed by the client application and providing input means for the user.

FIG. 5 shows an exemplary GUI for indicating the user's current happiness level.

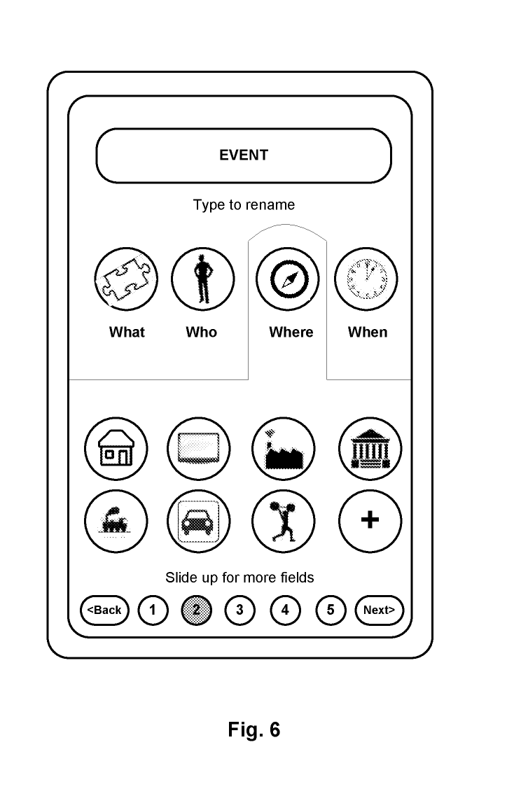

FIG. 6 shows an exemplary GUI for defining an event.

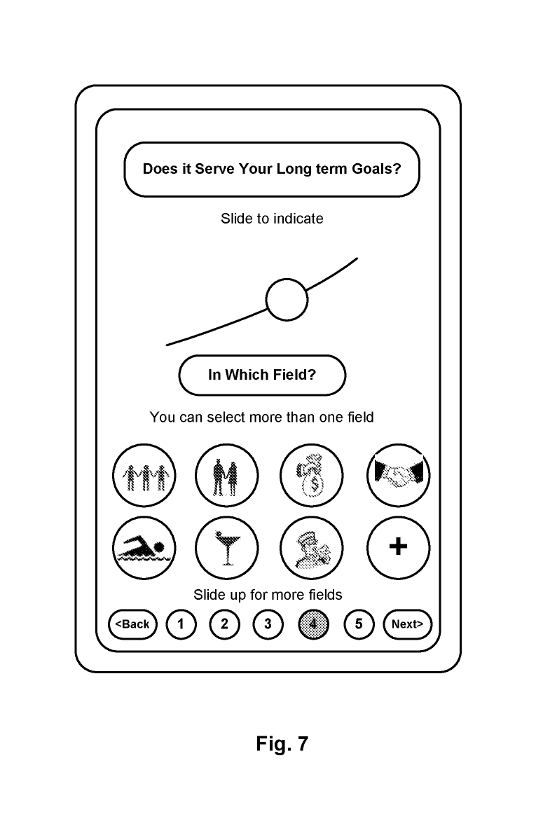

FIG. 7 shows an exemplary GUI for indicating long-term goals (contributors).

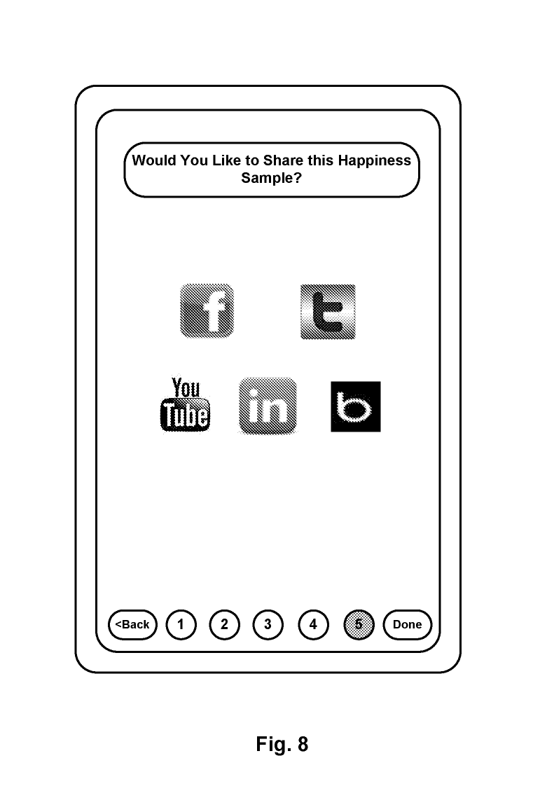

FIG. 8 shows an exemplary GUI for sharing the user's happiness parameters with selected social networks,

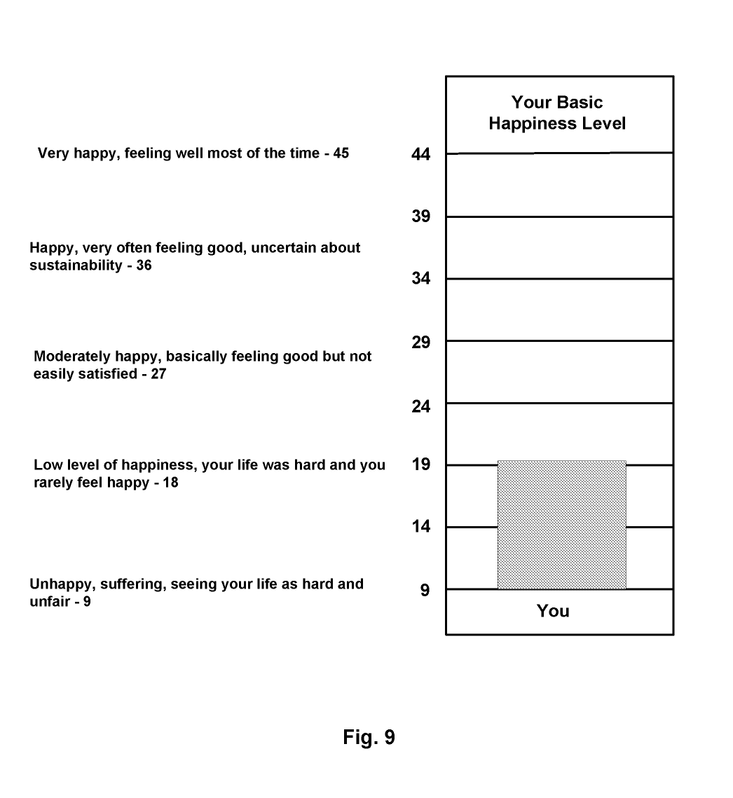

FIG. 9 shows an exemplary GUI for calculating a user's basic happiness level.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. A computerized method of online monitoring and quantifying by a server a user's level of happiness following an event or action, comprising:
a. receiving from the user a definition of an event or action via an electronic communication device;
b. receiving from the user at least one short-term and one long-term periods related to said event via said electronic communication device;
c. receiving from the user a definition of happiness contributors for each said defined periods via said electronic communication device;
d. associating grades to each of said contributors;
e. computing at the server a happiness level based on said defined happiness contributors' grades;
f. computing at the server a happiness rate of said user based on the computed happiness level and the number of periods, using the Net Present Value (NPV) formula, wherein the net present value is represented by said computed user's happiness level;
g. storing at the server said received and computed happiness parameters;
h. reporting said computed happiness parameters to the user;
i. repeating steps (a) through (h), wherein said previously stored happiness parameters are used to detect patterns in the user's happiness level; and
j. using said detected patterns to refine the NPV formula for the user.

2. The method of claim 1, wherein said associating grades comprises recording said user's voice via said electronic communication device and performing a computerized analysis thereof at the server.

3. The method of claim 1, wherein said associating grades comprises capturing said user's expressions via said electronic communication device and performing a computerized analysis thereof at the server.

4. The method of claim 1, wherein said electronic communication device is selected from the group consists of: a Smartphone, a personal computer, a tablet PC and a PDA.

5. The method of claim 1, further comprising using the NPV formula to help in the user's decisions based on achieving the highest happiness level as represented by the NPV.

6. The method of claim 1, further comprising retrieving additional data related to said defined event or action from personal electronic sources.

7. The method of claim 6, wherein said additional data comprises at least one of time and location of the event or action,

8. The method of claim 6, wherein said personal electronic sources comprise at least one of a Smartphone and a personal computer.

9. The method of claim 6, further comprising correlating said additional data with said user's happiness level.

10. The method of claim 1, further comprising retrieving additional data related to said defined event or action from public electronic sources.

11. The method of claim 10, wherein said additional data comprises at least one of weather, political events, social events and astrological events, correlated with the event or action.

12. The method of claim 10, wherein said public electronic sources comprise the Internet.

13. The method of claim 10, further comprising correlating said additional data with said user's happiness level.

14. The method of claim 1, further comprising reporting said computed happiness parameters.

15. The method of claim 1, further comprising providing means for sharing the computed happiness level with a selected list of online social networks.

16. The method of claim 1, further comprising storing the computed happiness level of a plurality of users at the server and performing correlations and pattern finding in said stored data.

17. A system for monitoring and quantifying a user's level of happiness following an event or action, comprising:
a server connected to a network, said server comprising a processor and configured to execute programmable commands of a server application;
at least one electronic communication device communicating with said server over a network, said electronic communication device comprising a processor and configured to execute programmable commands of a client application;
said electronic communication device additionally comprising a display configured to provide a GUI (Graphical User Interface) means for receiving user input and providing output to the user;
wherein said user GUI input means comprise:
means for defining an event or action;
means for defining at least one short-term and one long-term periods related to said event or action;
means for defining happiness contributors for each said defined periods; and
means for associating grades to each of said contributors;
said server processor further configured to:
compute a happiness level based on said defined grades;
compute a happiness rate of said user based on the computed happiness level and the number of periods, using the Net Present value (NPV) formula, wherein the net present value is represented by said user's happiness level; and
wherein said GUI means further comprise means for reporting said computed happiness parameters to said user.

18. The system of claim 17, wherein said electronic communication device further comprises recording means for recording said user's voice and transmit said recording to the server, said server processor further configured to analyze said recorded voice and refine said associated grades accordingly.

19. The system of claim 17, wherein said electronic communication device further comprises capturing means for capturing said user's expressions or voice and transmit said captured expressions or voice to the server, said server processor further configured to analyze said captured expressions and refine said associated grades accordingly.

20. The system of claim 17, wherein said GUI comprises means for sharing the computed happiness level with a selected list of online social networks.

21. The system of claim 17, wherein said electronic communication device is selected from the group consisting of Smartphone, personal computer, tablet PC and PDA.

22. A system for monitoring and quantifying a population's level of happiness following an event or action, comprising:
a server connected to a network, said server comprising a processor and configured to execute programmable commands of a server application;
multiple electronic communication devices communicating with said server over a network, each one of said plurality of electronic communication devices comprising a processor and configured to execute programmable commands of a client application;
each one of said plurality of electronic communication devices additionally comprising a display configured to provide a GUI (Graphical User Interface) means for receiving users input and providing output to the users;
wherein said user GUI input means comprise:
means for defining an event or action; and
means for defining a happiness level of a user,
said server processor further configured to compute statistics of happiness level of populations comprising multiple users; and
wherein said GUI means further comprise means for reporting said computed happiness level and statistics of said populations comprised of multiple users to other parties.

23. The system of claim 22, wherein said means for defining the happiness level of a user comprise means for capturing said user's expressions or voice.

24. The system of claim 22, wherein the computed statistics of happiness level of said population is presented by means of graphical or numerical data.

25. The system of claim 22, wherein said other parties comprise stake holders selected from the group consisting of: municipalities, government institutes, educational institutes and commercial organization.
